(19) United States
(12) Patent Application Publication
(10) Pub. No.: US 2025/0229335 A1
(43) Pub. Date: Jul. 17, 2025

(54) ADDITIVE MANUFACTURING METHOD WITH MODIFICATION OF PARTIAL LAYERS

(71) Applicant: TDK Electronics AG, München (DE)

(72) Inventors: Dominik REICHARTZEDER, Graz (AT); Thomas LENZEN, Graz (AT); Johann PICHLER, Breitenau am Hochlantsch (AT)

(21) Appl. No.: 18/855,823

(22) PCT Filed: Apr. 26, 2023
(86) PCT No.: PCT/EP2023/060901

§ 371 Date: Oct. 10, 2024

(30) Foreign Application Priority Data
May 3, 2022 (DE) 10 2022 110 873.2

(51) Int. Cl. B22F 10/50; B22F 10/60; B29C 64/188; B33Y 10/00; B33Y 40/20; B33Y 70/00

(52) U.S. Cl. CPC B22F 10/50; B22F 10/60; B29C 64/188; B33Y 10/00; B33Y 40/20; B33Y 70/00

(57) ABSTRACT

The invention relates to an additive manufacturing method comprising the steps:
additive application of a layer of material (1), and
modifying a part of the applied material layer (1) in a property so that a partial layer (3) in the material layer (1) is structured, the partial layer (3) differing from the remaining material layer at least in the modified property. The invention also relates to a correspondingly manufactured component and a suitable manufacturing apparatus.

### CROSS-REFERENCE TO RELATED APPLICATIONS

This application is a U.S. National Stage of International Application No. PCT/EP2023/060901, filed Apr. 26, 2023, 102022110873.2, filed May 3, 2022, both of which are incorporated herein by reference in their entireties.

### FIELD

The present application relates to an additive manufacturing method during which partial layers in components are modified.

### BACKGROUND

Numerous additive manufacturing methods are known in the state of the art. Additive manufacturing enables the structured construction of components, even with unusual shapes, without material loss through subsequent processing. The component is shaped during its manufacture.

Nevertheless, in the state of the art, components with certain components are limited or difficult or even impossible to additively manufacture. For example, electronic or catalytically active components are still attached separately in or on the component and cannot be printed during the additive manufacturing method.

### SUMMARY

An exemplary method for applying and modifying electrically conductive components, in particular on 2D substrates, is the application of a substrate material and its subsequent modification by means of a laser-induced graphene process, which is known, for example, from the publications US 2020/0 112 026 A1, US 2020/0 348 121 A1, CN 111 879 341 A or WO 2018 085 789 A1.

The electrical conductivity of the modified LIG material can be further increased in post-treatment steps, as shown in publications CN 109 440 145 A, US 2018/0 199 441 A1 and WO 2020 197 606 A2.

The publications US 2021/0 395 420 A1 and WO 2017 051 182 A1 also disclose high-temperature resistant materials from the state of the art.

CN 114322741 A shows an example of a manufacturing process for a ceramic film sensor. For this purpose, a metal component is provided as a substrate and a precursor layer for a ceramic insulating film is applied, e.g. by screen printing. However, the process does not allow the structuring of a partial layer in an already printed layer.

DE 102019101268 A1 discloses a process for the production and modification of objects containing silicon carbide.

WO 2017/176251 A1 shows a printing process in which a photosensitive additive is distributed on a section of a previously applied polymer layer using a liquid ink as a vehicle.

US 2018/0129002 A1 discloses various possible post-treatment steps for the surface treatment of additively manufactured electrical components.

Finally, U.S. Pat. No. 9,827,713 B1 and WO 2020/236455 A1 disclose special equipment for 3D printing that has several processing stations in which the individual steps of the printing process are carried out.

U.S. Pat. No. 9,827,713 B1 shows a robot arm that dips a substrate into different resins at several stations in order to form the different layers of a component.

In WO 2020/236455 A1, several plates are fused one after the other to form layers of a component.

One aim of the present application is to provide a method, a component and an apparatus which overcome the disadvantages of the prior art.

The present invention relates to an additive manufacturing method comprising several steps.

In a first step, a layer of material is applied additively. The layer can, for example, be applied to a building plate intended for this purpose or to a previously additively applied layer. The layer can comprise any material that is suitable for additive manufacturing or 3D printing.

In a further step, at least part of the previously applied material layer is modified in one property so that a partial layer is structured in the material layer. A partial region of the material layer can be referred to here as a partial layer. The partial layer differs in at least one property of the material from the rest of the material layer, outside the modified part of the layer. In one embodiment, the entire material layer is modified.

During modification, a chemical, a physical, a morphological and/or a structural property of the material layer can be changed, among other things. Among other things, in various embodiments of the invention, the electrical conductivity, the porosity or the grain size of the material layer is changed or an organic material is carbonized into an inorganic carbon material.

For example, a part of the applied material layer is modified in such a way that the electrical conductivity in that part of the layer is changed, thus structuring a partial layer whose electrical conductivity differs from the conductivity of the rest of the material layer.

During modification, several properties of the material layer can be changed by a modification step. For example, the partial layer structured after modification can differ from the rest of the material layer in terms of its electrical conductivity as well as its porosity and grain size.

The process described can be used to create a layer structure with various desired properties without having to print separate layers. Furthermore, the properties of the printed material layer can already be adjusted during the additive manufacturing method so that the corresponding post-processing steps can be dispensed with.

The targeted modification of properties of the previously additively manufactured layers also enables the additive manufacturing of components with properties that cannot be produced in a conventional additive manufacturing method. These properties include, in particular, the aforementioned properties of electrical conductivity, grain size, porosity and other comparable material properties.

After the material layer has been applied and modified, a further material layer can be applied in a further process step and again modified in such a way that at least one material property in the part of the layer is changed and thus a partial layer is structured which differs in a material property from the conductivity of the remaining material layer. Alternatively, a material layer can also be applied in which no partial layer is modified.

In particular, the partial layer can be structured so that it matches the partial layer in the first material layer and the two partial layers form a coherent layer with homogeneous properties, for example.

In particular, in one embodiment, the same electrical conductivity is set in the partial layer and the further partial layer. In this way, an electrically conductive layer, for example an inner electrode, can be structured in an electrically non-conductive material.

In one embodiment, the material layer and the further material layer are applied directly on top of each other or directly next to each other. In further embodiments, the material layers can be applied both next to each other and on top of each other.

The material layer can consist of different materials, in particular a structural material and a modifiable material.

In particular, the different materials are applied in several steps of the printing process. A structural material is not suitable for the modification step described, but does provide a desired structure for the component to be manufactured.

A modifiable material is suitable for modification during the modification step. This means that part of the modifiable material can be modified to create a structure with the desired properties.

The modifiable material should preferably be a high-temperature-resistant material that can be 3D printed using bath-based photopolymerization, such as the plastic classes ThermoBlast or DL-400.

A material can be considered “high-temperature resistant” if it can withstand an ambient temperature of at least 300° C. Accordingly, the melting or decomposition point of a high-temperature resistant material is above 300° C. and the structure of the high-temperature resistant material is not changed at temperatures up to 300° C.

These can be active layers or internal electrodes in the material layers, for example. The remaining material layer, which is not modified, continues to contribute to the overall structure of the component.

In one embodiment, the material layer or the further material layer comprises ceramic materials.

In a further embodiment, the material layer or the further material layer comprises metals.

In a part of the applied material layer, the layer material can then be modified by sintering and thus the structuring of the partial layer can be carried out. The partial layer can, for example, comprise or consist of a metal or ceramic material.

Targeted, spatially resolved sintering enables the structuring of specific partial layers with desired properties. For example, the ceramic material can be modified during sintering so that conductive metallic partial layers are formed in the ceramic layer. An organic material with metallic or ceramic inclusions can, for example, be modified in such a way that organic components are removed and metallic or ceramic partial layers are formed that predominantly comprise a metal or ceramic or consist of such a material.

Sintering also modifies the porosity of the partial layer. In particular, structures with larger pores can be formed. By modifying the pores, for example, the suitability of the material as a catalyst, carrier substance or filter unit can be adjusted.

In a further embodiment, the material layer or the further material layer comprises an organic material or consists of organic material. The organic materials, in particular plastics, preferably additionally incorporate ceramic and/or metal materials which can be modified, for example as described above.

Preferably, the material layer or the further material layer comprises plastics or consists of plastics.

In addition, natural materials such as cellulose-based materials, modified natural materials such as rubber, viscose and cellophane can also be used as organic materials.

Various plastics can be used. In particular, homogeneous material layers made from a uniform base material are preferable. Possible materials include PI, PEI, PE, PP, etc.

Blends, i.e. non-chemically cross-linked mixtures, of two pure plastic materials or chemically cross-linked copolymers such as ABS are also conceivable. In further embodiments, the materials of the material layers also include composite materials such as GSK or PCB or polymer materials with fillers such as embedded ceramic or metal particles.

In one embodiment, a partial layer in the plastic material can be structured by converting the plastic into inorganic carbon.

It is particularly preferable to use a high-temperature-resistant plastic to which the laser-induced graphene process can be applied and which can be 3D printed, especially by means of bath-based photopolymerization. Due to their chemical composition and processability at high temperatures, high-temperature-resistant plastics are particularly suitable for the application of the LIG process. A targeted conversion of the organic material by laser into graphene or graphite structures of the carbon is possible here.

The plastics composition preferably comprises at least one monomolecular or oligomeric chemical species, each comprising at least one carbon-carbon double bond polymerizable by free radical polymerization, wherein the monomolecular or oligomeric chemical species is present in a total amount of 25 to 99% by weight based on the plastics composition.

Preferably, the plastic composition further comprises at least one photoinitiator, particularly preferably a titanocene photoinitiator, which is preferably present in a total amount of from 0.1 to 15% by weight, and further comprises at least one coinitiator, particularly preferably a thiol co-initiator, which is preferably present in a total amount of from 0.5 to 20% by weight.

Alternatively, the plastic composition comprises, for example, a thermosetting component A having one or more chemical species selected from the group consisting of monomers and/or oligomers and/or prepolymers of maleimide derivatives according to formula (I) and isomers thereof, wherein:
n is an integer between 1 and 10,
R₁ H, CH₃ or CH₂, and
R₂ is independently a linear, branched or cyclic aliphatic or aromatic C5-C40 radical from one or more of the groups phenyl, benzyl, phenethyl, methyl, ethyl, propyl, butyl, pentyl, hexyl, octyl, decanyl, dodecanyl, acetic acid, propanoic acid, butanoic acid, pentanoic acid, undecanoic acid, dodecanoic acid, benzoic acid and corresponding esters, alkyl or aromatic esters, cyclopropyl, cyclobutyl, cyclopentyl, cyclohexyl, cycloheptyl, cyclooctyl, adamantyl, isobornyl, propenyl, biphenyl, naphthyl, anthracenyl, pyrenyl, bis(methylene)oxy, bis(ethylene)oxy, bis(phenyl)methane, bis(phenyl)ethane, bis(phenyl)propane, bis(phenyl)butane, bis(phenyl)ether, bis(phenyl)thioether, bis(phenyl)amino or bis(phenyl)sulfone.

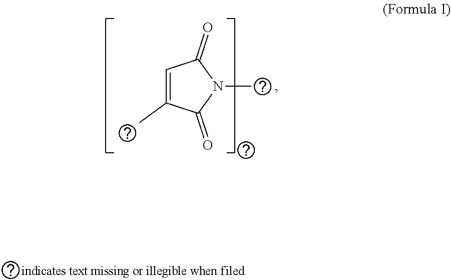

The plastic composition then further comprises a photocurable component B having one or more chemical species selected from the group consisting of (meth)acrylate, (meth)acrylamide, vinyl ester, vinyl ether, vinyl, allyl, alkynyl or styrene compounds and derivatives thereof substituted with at least one molecule from the group from which component A is selected, wherein the amount of component A is in the range of from 30 wt. % to 95% by weight, based on the total weight of components A and B, and the amount of the light-curable component B is in the range from 5 to 70% by weight, based on the total weight of components A and B.

Particularly preferably, component A then comprises a species of component A, where n is an integer from 2 to 10, which has an aromatic radical bonded to the N atom of the maleimide ring of the formula I, preferably via a methylene group, in an amount in the range from 20% by weight to 100% by weight, preferably from 30% by weight to 100% by weight and even more preferably from 40% by weight to 100% by weight, based on the total weight of component A.

The partial layer in the plastic can be modified by means of a suitable process and, in particular, converted into inorganic carbon. Examples of such suitable processes are thermal processes, mechanical processes such as grinding or roughening or ultrasonic processes, the use of plasma, irradiation, for example by electron beams, lasers, UV-VIS radiation, IR radiation or X-ray radiation, microwave radiation and chemical processes such as etching or chemical activation of the surface.

For example, a partial layer in the plastic can be structured using a laser-induced graphene process. In the laser-induced graphene process, also known as the LIG process, the treated material is chemically and/or physically stimulated and changed by the effect of laser radiation at the point of impact of the energy. In particular, a thermal transformation or decomposition occurs at the point of impact.

Specifically, in the LIG process, the organic carbon of the plastic is converted into inorganic carbon modifications such as graphene, graphite or fullerenes (“carbonization”) by means of targeted energy input using laser radiation. The LIG process is therefore generally not limited to the specific conversion of carbon into graphene, but can also include the conversion of carbon into other inorganic modifications.

In particular, electrically conductive carbon structures can be formed in the material layers. Furthermore, the aforementioned inorganic carbon modifications also differ in terms of their porosity and crystallinity, for example.

In particular, the LIG process can be used to make modifications specifically on the surface of a material layer or to make modifications that penetrate deep into the material layer and possibly cover the entire thickness of the partial layer.

In one embodiment, the material layer comprises auxiliary materials that support the laser-induced graphene process, such as catalysts, pre-dopants or reactive groups in particular.

For example, metal particles, metal salts or metal complexes dispersed in the layer can be used as catalysts.

In particular, the carbon materials to be produced and their derivatives can be used as pre-dopants.

In various embodiments, short-chain organic molecules with suitable reactive (end) groups, such as aromatic compounds, are used as reactive groups.

The additives mentioned are preferably used in trace amounts. The process is preferably carried out without the explicit addition of additives. In particular, the additives may already be present in trace amounts in the raw materials used.

In one embodiment of the method, the structured partial layer is subjected to a post-treatment step in order to further modify the properties of the partial layer and, in particular, to reinforce the properties set by modification. Preferably, a surface treatment is carried out for this purpose on a partial layer structured on the surface of the material layer.

The desired properties of the finished component can be set during the additive manufacturing method.

In one embodiment, in which the structured partial layer has at least an increased electrical conductivity compared to the remaining material layer, a possible post-treatment step comprises a surface treatment of the structured partial layer to further increase the electrical conductivity of the partial layer.

For example, surface treatment includes processes such as electroplating, sputtering or screen printing or sub-steps thereof. However, surface treatment is not limited to the aforementioned processes. In particular, metallic surface coatings with high electrical conductivity can be applied using the aforementioned processes. The electrical conductivity of the partial layer can thus be significantly increased.

Another surface treatment option is the application of a catalyst to enhance the catalytic properties of the modified material. In this context, a catalyst is any form of catalytically active material that can be applied in powder form, for example. In particular, the catalyst can be applied to the surface or introduced into the pores of the modified material.

In an optional step, in one embodiment, a seed layer is applied to the surface of the structured partial layer before one of the aforementioned surface treatment steps, which serves as the basis for the subsequent surface treatment. In particular, such a seed layer can facilitate the application of metallic material and thus, for example, simplify and/or accelerate an electroplating process or a screen printing process or a sputtering process. In particular, the seed layer can be a nano-scale seed layer.

In some embodiments, the structured partial layer has at least an increased porosity compared to the remaining material layer.

In an optional post-treatment step, conductive materials can then be introduced into the pores of the structured partial layer to increase the conductivity of the material.

Preferably, the post-treatment step is carried out in the embodiments before the further material layer is applied. In this way, each individual material layer can be modified separately and the modified properties can be enhanced.

The additive manufacturing method itself, i.e. the additive application of the material layers (3D printing), can be carried out using any suitable manufacturing process such as vat photopolymerization, material extrusion, material jetting, binder jetting, powder bed fusion, direct energy deposition or sheet lamination.

Due to its high precision, the vat photopolymerization process is particularly suitable for the process described here.

In one embodiment, several partial layers in the material layer are structured in one step. For this purpose, for example, a material layer is irradiated with several lasers in order to carry out several LIG processes in parallel. Similarly, several sintering processes or similar modification steps can also be carried out in parallel on several sections of the material layer.

Preferably, a component is formed from several material layers in the process, whereby partial layers are then structured in several of the material layers as described.

Preferably, no structured partial layer is formed in at least one material layer. In particular, such a material layer can consist of structural material. The structural material can be a non-modifiable material. Such a layer can, for example, increase the stability of the component or define the structure of the component.

The structured partial layers can be arranged randomly or in a specific system. In one embodiment, the structured partial layers are arranged in such a way that several partial layers of adjacent material layers are adjacent to each other. For example, several electrically conductive modified partial layers can be adjacent to one another in such a way that an internal electrode is formed in the component.

In embodiments of the manufacturing process, any number and sequence of auxiliary steps can be carried out between and/or after the aforementioned manufacturing steps. In particular, this may involve the steps of cleaning, washing, rinsing, neutralizing, activating, drying, etc. The exact selection and sequence depends, for example, on the component to be manufactured, its desired properties, the material used or the additive manufacturing method used.

In particular, if the applied and modified material layers are present as green layers, steps for debinding and sintering can follow.

Furthermore, in embodiments of the manufacturing process, further, usually final, steps may follow after the last layer of material has been applied. These may include, for example, assembly, external metallization, insulation, painting, debinding and sintering. The specific steps are preferably based on the component to be produced, its desired properties, the material used or the additive manufacturing method used. The steps can be carried out one after the other or simultaneously.

The present invention is also directed to an electrical component manufactured according to the described method. Such a component can have all of the properties described above in the course of the method.

In one embodiment, the component comprises several material layers, whereby several of the material layers comprise structured partial layers with increased electrical conductivity. In a preferred embodiment, no structured partial layer is formed in at least one material layer.

In particular, the electrical component can be designed as an electrical capacitor, e.g. as a plate capacitor. The plates of the capacitor are then preferably aligned vertically to the stacking direction of the additive manufacturing method. The inner electrodes of the capacitor are formed by several adjacent modified partial layers with increased electrical conductivity. In between, there are unmodified sections with lower or no electrical conductivity in each material layer.

The present invention is also directed to an apparatus for carrying out the described process for manufacturing the component. The apparatus comprises at least one transport system and individual processing stations at which the steps of the process are carried out. The transport system is then designed in such a way that the component can be transported from station to station in the operating state or the stations can be moved to the component. In this way, all processing steps of the process can be carried out using one apparatus.

### BRIEF DESCRIPTION OF THE DRAWINGS

In the following, the invention is described in more detail with reference to embodiments and associated figures. The invention is not limited to the embodiments shown in the following figures.

FIG. 1: Work surface with additively applied material layer.

FIG. 2: Material layer after modification to form partial layers.

FIG. 3: Post-treatment of the surface of the modified material layer.

FIG. 4: Component after the application of a second material layer.

FIG. 5: Component with two modified material layers.

FIG. 6: Post-treatment of the surface of the second modified material layer.

FIG. 7: Component after application of a third material layer.

FIG. 8: Alternative embodiment of a component after the formation of partial layers in a first material layer.

FIG. 9: Alternative embodiment of a component after the formation of partial layers in a second material layer.

FIG. 10: Cross-section of an exemplary component with various layers of material arranged on top of and next to each other.

FIG. 11: Another exemplary component with different material layers.

FIG. 12: Microscope image of porous LIG-modified plastic material.

### DETAILED DESCRIPTION

Similar or apparently identical elements in the figures are marked with the same reference symbol. The figures and the proportions in the figures are not to scale.

FIGS. 1 to 7 schematically show an exemplary additive manufacturing method. In a first step, shown in FIG. 1, a layer of material 1 is applied to a work surface 2. The material layer 1 is applied using a suitable additive process. Examples of additive processes that are suitable here are vat photopolymerization (VPP), material extrusion (MEX), material jetting (MJT), binder jetting (BJT), powder bed fusion (PBF), direct energy deposition (DED) and sheet lamination (SHL). The VPP process is particularly preferred due to its high printing accuracy. Other common additive processes can also be used.

For example, material layer 1 comprises a single homogeneous material. When building up the other material layers, the same homogeneous material can always be used in the further course of the process so that all material layers comprise the same material.

Alternatively, two or more materials with different mechanical, electrical, optical, chemical, biological or toxicological properties can be used to build up a single or different material layers.

A material is, for example, a structural material that defines the mechanical properties of the component. The structural material can also have other desired properties such as electrical properties or thermal properties. In addition to the structural material, a modifiable material that can be converted particularly well into a conductive material may be present in the same layer or in other layers.

In a first example, the material layer 1 is a plastic layer that comprises or consists of plastic materials. In addition to plastic, material layers made of natural materials, such as cellulose, are also conceivable.

The plastic layer can comprise modified natural materials such as rubber, viscose or cellophane or any industrially produced polymers such as polyimide (PI), polyethylene (PE), polypropylene (PP) and their derivatives such as PEI etc. Both material layers made of uniform materials and chemically non-crosslinked blends of two or more materials are possible. Other possible materials include chemically cross-linked copolymers such as ABS as well as composite materials such as GRP, PCB and polymer materials with fillers such as polymers with embedded ceramic particles.

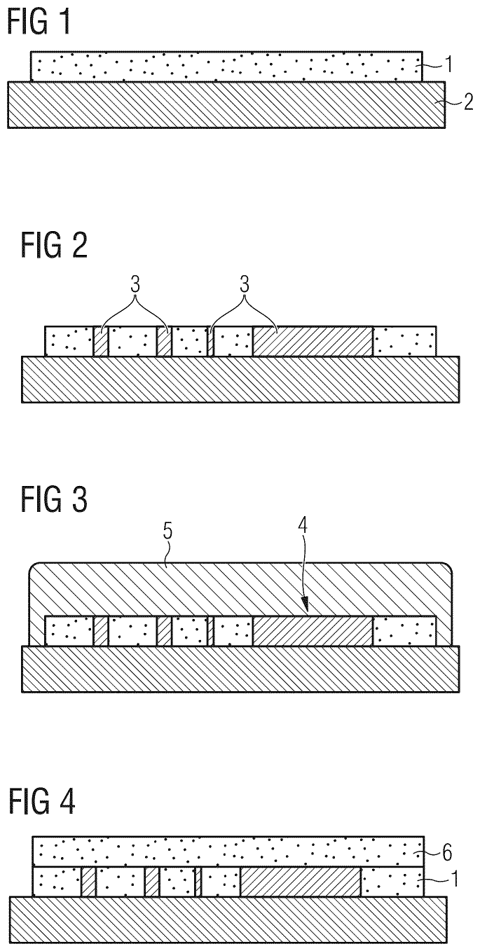

In a second process step, some sections of the material layer 1 are modified. The modified layer is shown in FIG. 2. The partial sections can be connected or separated. The partial sections can comprise any parts of the previously applied material layer 1. The partial sections and their dimensions can be specifically selected.

For example, the layer thicknesses of the material layers can also be selected in such a way that the desired properties of the layer composite are optimized to their target values. The geometric expansion of the material layers can be controlled in the material application and modification steps. In particular, the individual layers can be applied additively in different forms in the first step. In the second step, the modification can also change the expansion of partial layers in a stacking direction of the material layers. This means that both the structural material and the modifiable material can be present in one plane.

In the first example, the modification of partial sections of the material layer 1 is carried out using a LIG process. During this process, restructured partial layers 3 are created in the material layer 1 in the corresponding subsections. The partial layer 3 differs from the remaining material layer in at least one property. For example, the partial layer 3 differs from the remaining material layer 1 in terms of its electrical conductivity or, for example, its porosity. Furthermore, the partial layer 3 may alternatively or additionally also differ from the remaining material layer in terms of the grain size or with regard to the carbonization of the material.

In particular, the structured partial layer is electrically conductive and the remaining material layer 1 is hardly or not electrically conductive. In particular, the porosity of the structured partial layer 3 is also higher than that of the remaining layer. A microscope image of the highly porous LIG-modified plastic material of the partial layer 3 is shown in FIG. 12.

The patterning can be applied only to the surface of the partial layer 3, over part of the layer thickness or, as shown, over the entire layer thickness.

During the LIG process, the plastic material is thermally induced and chemically converted by a laser, resulting in a structure based on inorganic carbon material. The structured partial layer can, for example, have a material based on graphene, graphite, fullerene, their (partially) oxidized derivatives or similar.

Preferably, the (organic) plastic material of the remaining material layer 1 is electrically non-conductive and the material of the structured partial layer 3 is electrically conductive.

The LIG process can be supported by auxiliary materials such as suitable catalysts, pre-doping in the material layer 1 and reactive groups introduced into the material layer 1. Catalysts can be metal particles, metal salts or metal complexes dispersed in the material layer 1. Pre-dopants can in particular be the carbon materials to be produced and their derivatives. Reactive groups can be short-chain organic molecules with suitable reactive (end) groups such as aromatic compounds.

The additives mentioned are used in trace amounts. Preferably, the process takes place without the explicit addition of additives. In particular, the additives may already be present in trace amounts in the raw materials used.

In a third step, which is shown in FIG. 3, the structured partial layer 3 is post-treated. In this example, an electrically conductive metal such as copper, silver, gold, platinum or palladium is applied to the pores of the partial layers 3 and/or as a thin film 4 on the surfaces of the partial layers 3 using a suitable process.

Such a suitable process can be an electroplating process such as e.g: Electroplating, electroless plating, adsorption etc.

Alternatively, the coating can also be applied by sputtering, infiltration or screen printing, for example.

The treatment of the surface is indicated schematically in FIG. 3 by a cap 5, which covers the surface to be treated. In particular, this may be an apparatus by means of which the surface is treated.

In an optional step, a seed layer is applied to the surface of the structured partial layers 3 before the surface treatment described, which serves as the basis for the subsequent surface treatment. In particular, such a seed layer can facilitate the application of metallic material and thus, for example, simplify and/or accelerate the electroplating process or the screen printing process or the sputtering process. For example, the seed layer is a nano-scale seed layer.

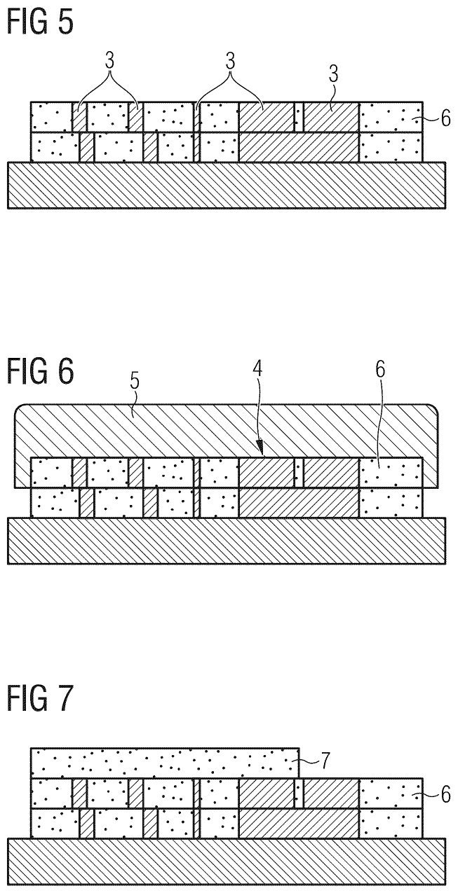

Subsequently, in a fourth step, shown in FIG. 4, a further material layer 6 is applied to the first material layer 1 and, as shown in FIGS. 5 to 7, the further process steps of modifying the applied material layer 6 (FIG. 5), post-treatment of the surface (FIG. 6) and, if necessary, application of further layers (FIG. 7) are repeated once or several times. As shown in FIG. 5, the partial layers 3 are preferably modified in such a way that several partial layers of material arranged on top of each other form a coherent structure.

Optionally, a material layer 7 as shown in FIG. 7 may not extend over the entire surface of the underlying material layer.

The layers of material can optionally also be applied next to each other.

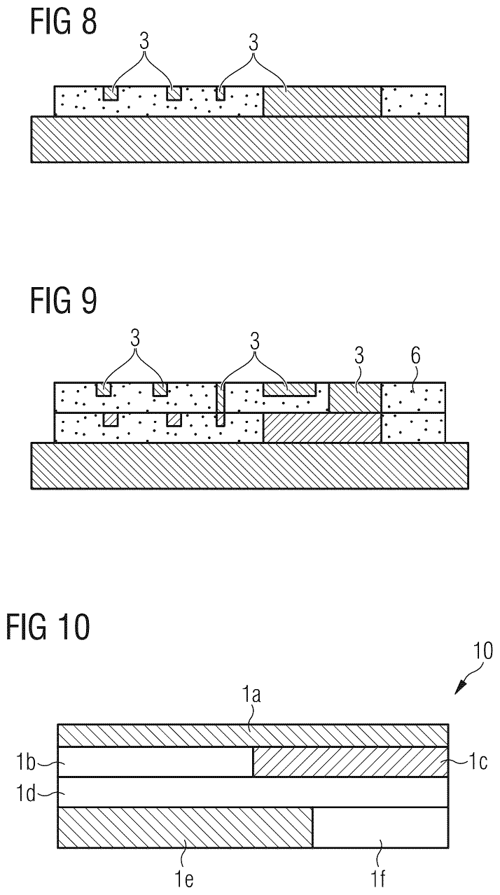

FIGS. 8 and 9 show an alternative embodiment. In this embodiment, the partial layers are partially structured only on the surface of the material layer and partially over the entire layer thickness.

The individual structured partial layers of several neighboring material layers are partially connected or, for example, also form independent structures that are not connected. This is also shown in FIGS. 8 and 9. A structure can comprise a single partial layer.

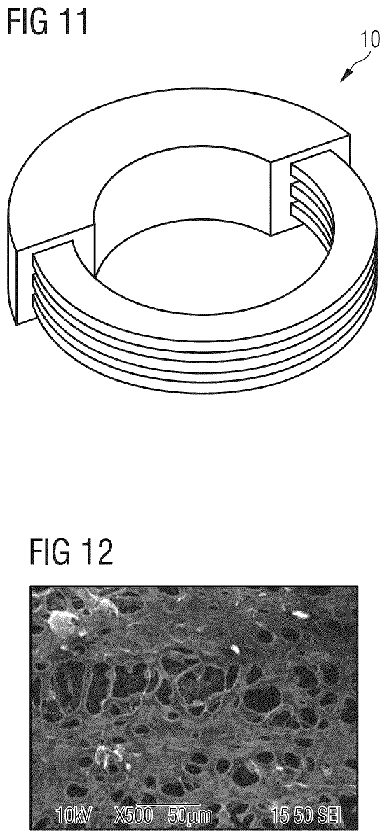

Exemplary representations of finished components 10 with several layers of material printed on top of each other are shown in FIGS. 10 and 11. FIG. 10 shows a cross-sectional view.

In this way, a component can be manufactured that comprises a large number of material layers and partial layers 1a to 1f made of different materials. For example, 1 and 1f form a layer that comprises different materials. The method described above can be used to structure electrically conductive structures in the component. This means that an electrical component can be additively manufactured without the need for further post-treatment steps. For example, a capacitor element, e.g. a plate capacitor, can be manufactured in this way.

In a second example, the material layer 1 comprises an organic material in which a ceramic material is embedded. The ceramic material comprises a metallic element in its composition. The ceramic material is not further restricted. In the second step of the process, metallic and electrically conductive structures are then produced on selected sections of the ceramic layer by selective sintering of the ceramic material. Furthermore, ceramic partial layers can be produced that no longer contain any organic material.

In a third example, the material layer 1 comprises an organic material in which a metal is embedded, which is sintered in the second step of the process at selected partial sections of the material layer 1 in order to produce metallic partial layers as electrically conductive structures.

There may be any number and sequence of auxiliary steps between and/or after the aforementioned production steps. In particular, these are the steps of cleaning, washing, rinsing, neutralizing, activating, drying, etc. The exact selection and sequence depends on the component to be manufactured, its desired properties, the material used, the additive manufacturing method used, etc.

Furthermore, final steps can follow after the last layer of material has been applied. These may include, for example, assembly, external metallization, insulation, painting, debinding and sintering. Here too, the steps performed depend on the specific component to be produced, its desired properties, the material used, the additive manufacturing method used, etc.

An apparatus required for the described process can essentially consist of a transport system, such as a robot arm or conveyor belt, and individual processing stations. The component to be assembled can either be transported from station to station or the stations can be moved to a fixed component to be assembled.

Essentially, the process described can be used to manufacture all conceivable products that consist of an additively applied organic material or plastic and optionally also of a ceramic material and/or a metal and have some kind of electrical contacting.

Additively manufactured components always comprise an additively applied organic material and optionally, for example, embedded ceramic and/or metal particles. A modified partial layer can also be reinforced with a metallic surface coating such as Cu, Pd, Au, Ag, Ni, etc.

This allows a plastic component to be manufactured in which ceramic layers—for the desired functionalities—and metallic layers—e.g. for electrical contacting—are embedded.

This means that a multilayer component comprising plastics, ceramics and metals can be produced by additive manufacturing, for example by 3D printing, with modification steps.

An additively manufactured green body must then be sintered in order to obtain the finished, ready-to-use component.

For example, passive electronic components can be manufactured, preferably multilayered and with internal electrodes and with carrier substrates made of plastic, such as PCB, FR4 and/or ceramics such as AlOx or AlN, PZT, PLZT, PCZT, ferrite, varistor ceramics such as ZnO, PTC ceramics, NTC ceramics, LTCC, HTCC.

In one embodiment, the process described can be used, for example, to produce a layered structure of a capacitor with internal electrodes.

A layer of plastic material is provided for this purpose. A section on the surface of the plastic layer is modified in such a way that the electrical conductivity changes compared to the plastic. The conductivity is specifically increased in order to form an electrode of the capacitor.

The modification is carried out as described above by converting the plastic into a conductive carbon derivative in the LIG process. The modified partial layer is then reinforced by electroplating copper and the conductivity is further increased.

The next layer of plastic is then applied over the first layer of material.

This is then also modified to form the next electrode layer and so on, until a further plastic layer is applied in the final process step, which is not modified any further. The modifications can extend over the entire thickness of the material layer.

The partial layers with increased conductivity then form the inner electrodes of the capacitor. The partial layers are arranged in such a way that partial layers of neighboring material layers adjoin each other and form a coherent, uniform electrode structure.

Such an electrode structure, which forms an inner electrode of the capacitor, then extends perpendicular to the stacking direction of the material layers. The intermediate layer sections with lower conductivity act as separators.

The result is a component that has a first material layer on its underside, which is only modified on its upper side, then comprises any number of material layers with modifications that form the actual capacitor, and comprises an unmodified plastic layer on its upper side as a final layer.

As additional auxiliary steps, unused raw material can be returned after each material layer has been prepared and the surface of the material layer produced can be cleaned. The LIG process is then carried out and cleaned again. After galvanic copper plating, the material layer is neutralized, washed, rinsed and dried.

If a ceramic-containing plastic material is used for the capacitor, e.g. ceramic particles embedded in a polymer matrix, the process can be completed with debinding or sintering steps and hard machining steps such as grinding.

At the end of the process, once all the layers of material have been applied, an external contact can be applied to the outside of the capacitor by sputtering or similar suitable processes and the remaining surface of the capacitor can be coated with a protective coating/insulation. In addition, the capacitor can be assembled, e.g. cut to size, and an additional housing can be applied.

### LIST OF REFERENCE SYMBOLS

1 First layer of material
2 Work surface
3 Partial layers
4 Thin film
5 Schematic cap for surface treatment
6 Additional material layer
7 Additional material layer with smaller dimensions
10 Additively manufactured component
1a, 1b, 1c, 1d, 1e, 1f Material layers

1-31. (canceled)

32. An additive manufacturing method comprising:
(a) additively applying a material layer; and
(b) modifying a property of a portion of the applied material layer to obtain (i) a partial layer in the material layer and (ii) a remaining material layer in the material layer,
wherein the partial layer is structured, and the partial layer differs from the remaining material layer in at least the modified property.

33. The additive manufacturing method according to claim 32, further comprising:
(c) additively applying a further material layer to the material layer; and
(d) modifying a property of a portion of the further material layer to obtain (iii) a partial layer in the further material layer and (iv) a remaining material layer in the further material layer,
wherein the partial layer in the further material layer is structured, the partial layer in the further material differing from the remainder of the further material layer at least in the modified property.

34. The additive manufacturing process according to claim 33, wherein steps (a) through (d) are performed in the specified order.

35. The additive manufacturing method according to claim 33, wherein the material layer and the further material layer are applied directly on top of and/or next to each other.

36. The additive manufacturing method according to claim 32, wherein the material layer consists of structural material and modifiable material.

37. The additive manufacturing method according to claim 32, wherein the material layer comprises ceramic materials or metals.

38. The additive manufacturing method according to claim 37, wherein the material layer consists of metals.

39. The additive manufacturing method according to claim 37, wherein sintering is carried out in a part of the applied material layer to structure the partial layer.

40. The additive manufacturing method according to claim 32, wherein the material layer comprises plastics.

41. The additive manufacturing method according to claim 40, wherein the plastics are resistant to high temperatures.

42. The additive manufacturing method according to claim 40, wherein in a part of the applied material layer the plastic is converted into inorganic carbon to structure the partial layer.

43. The additive manufacturing method according to claim 42, wherein the partial layer is structured by a thermal process, thermal processes, irradiation by electron beams, lasers, UV-VIS radiation, IR radiation or X-ray radiation or microwave radiation.

44. The additive manufacturing method according to claim 42, wherein the partial layer is structured by a mechanical process, the application of plasma or a chemical process.

45. The additive manufacturing method according to claim 42, wherein a laser-induced graphene process is carried out in a part of the applied material layer to structure the partial layer.

46. The additive manufacturing method according to claim 45, wherein the material layer comprises auxiliary substances which support the laser-induced graphene process, the auxiliary substances including one or more of catalysts, pre-dopants or reactive groups.

47. The additive manufacturing method according to claim 32, wherein the structured partial layer has at least an increased electrical conductivity compared to the remaining material layer, the method further comprising:
a post-treatment step for surface treatment of the structured partial layer to further increase the electrical conductivity.

48. The additive manufacturing method according to claim 47, further comprising:
(c) additively applying a further material layer to the material layer; and
(d) modifying a property of a portion of the further material layer to obtain (iii) a partial layer in the further material layer and (iv) a remaining material layer in the further material layer,
wherein the partial layer in the further material layer is structured, the partial layer in the further material differing from the remainder of the further material layer at least in the modified property, and
wherein the post-treatment step is carried out before the application of the further material layer.

49. The additive manufacturing method according to claim 47, further comprising:
applying a seed layer to the surface of the structured partial layer before the post-treatment step, the seed layer serving as a basis for the subsequent surface treatment.

50. The additive manufacturing method according to claim 47, wherein the surface treatment comprises a process step of electroplating, sputtering or screen printing.

51. The additive manufacturing method according to claim 32, wherein the modified property is an electrical conductivity and/or a grain size distribution and the partial layer has at least an increased electrical conductivity and/or a modified grain size distribution compared to the remaining material layer.

52. The additive manufacturing method according to claim 51, wherein an electrically conductive or catalytically active material is introduced into pores of the partial layer in a post-treatment step.

53. The additive manufacturing method according to claim 32, wherein the modified property is a porosity and the partial layer has at least an increased porosity compared to the remaining material layer.

54. The additive manufacturing method according to claim 32, wherein the additively applying the material layer is carried out by means of one of the additive processes including Vat photopolymerization, material extrusion, material jetting, binder jetting, powder bed fusion, direct energy deposition or sheet lamination.

55. The additive manufacturing method according to claim 32, wherein a plurality of partial layers in the material layer are structured in one step.

56. The additive manufacturing method according to claim 32, wherein the partial layer is structured only on a surface of the material layer or wherein the partial layer is structured over an entire layer thickness of the material layer.

57. The additive manufacturing method according to claim 32, wherein a component is formed from a plurality of material layers, wherein partial layers are structured in a plurality of the material layers and no structured partial layer is formed in at least one material layer of the plurality of material layers.

58. The additive manufacturing method according to claim 57, wherein the structured partial layers are arranged to form internal electrodes in the component.

59. The additive manufacturing method according to claim 57, wherein the applied and modified material layers of the component are debinded and sintered in a further process step.

60. The additive manufacturing method according to claim 57, wherein further manufacturing steps follow for manufacturing the component, the further manufacturing steps including fabrication, external metallization, insulation, coating, debinding and sintering, wherein the manufacturing steps are carried out successively or simultaneously.

61. An electrical component produced according to the method of claim 32, the electrical component comprising:
a plurality of material layers comprising
one or more material layers including structured partial layers with increased electrical conductivity or increased porosity or changed grain size distribution, and
another one or more material layers having no structured partial layer.

62. The electrical component according to claim 61, wherein the electrical component is an electrical capacitor.

63. An apparatus, comprising:
individual processing stations configured to manufacture a component by:
(a) additively applying a material layer, and
(b) modifying a property of a portion of the applied material layer to obtain (i) a partial layer in the material layer and (ii) a remaining material layer in the material layer,
wherein the partial layer is structured, and the partial layer differs from the remaining material layer in at least the modified property; and
a transport system, wherein the transport system is designed in such a way that in the operating state:
(c) the component can be transported from a first individual processing station to a second individual processing station, or
(d) the first individual processing station can be moved to the component,
wherein the component comprises a plurality of material layers comprising:
one or more material layers including structured partial layers with increased electrical conductivity or increased porosity or changed grain size distribution, and
another one or more material layers having no structured partial layer.
